(19) United States
(12) Patent Application Publication
(10) Pub. No.: US 2015/0192076 A1
(43) Pub. Date: Jul. 9, 2015

(54) ACCELERATOR PEDAL ASSEMBLY APPARATUS

(71) Applicant: Hella Corporate Center USA, Inc., Plymouth, MI (US)

(72) Inventor: Nicholas Michael Jordan, Ann Arbor, MI (US)

(21) Appl. No.: 14/147,386

(22) Filed: Jan. 3, 2014

(51) Int. Cl. F02D 11/10; G05G 5/03; G05G 1/38

(52) U.S. Cl. CPC F02D 11/107; G05G 1/38; G05G 5/03

(57) ABSTRACT

A pedal assembly having an electronic position sensor for actuating acceleration and deceleration through electronic signals sent from the position sensor to a processor associated with a throttle to coordinate acceleration, speed maintenance or deceleration to the position signals received from the pedal assembly. Resistance to pedal movement may be provided by a friction element engaged with a friction surface. The pedal may be fixedly attached to a pedal lever arm which may be engaged with the friction element. The pedal lever arm may disengage the friction element to allow the pedal lever arm to return to idle if the friction element becomes stuck. Further, a moveable engagement between the spring carrier and the friction element may allow biasing force from a spring to be applied to the pedal lever arm when movement of a portion of the spring carrier is inhibited by the friction element being stuck.

### BACKGROUND OF THE INVENTION

### Field of the Invention

The present invention is in the field of accelerator pedal assemblies having electronic position sensors.

### CROSS REFERENCE TO RELATED APPLICATION

None.

### RELATED ART

Although automotive, truck and commercial specialty vehicles now commonly use electronic position sensors in accelerator pedals, instead of the old lever and cable mechanisms in order to actuate engine throttle movement to accelerate the vehicle, some physical resistance to pedal movement is still the standard. The old lever and cable assemblies generated a sufficient resistance to movement to help prevent driver leg fatigue. Friction in the cables decreased the force necessary to maintain a selected accelerator pedal position. To simulate this preferred resistance in the modern accelerator pedals having electronic sensors, vehicle manufacturers have established a standard for incorporating friction into the position sensor pedal assemblies.

A variety of linkages and assemblies have been designed and built to meet this industry standard. Typically a pedal and its extension, a pedal lever arm, are linked to some friction element disposed to generate friction throughout the range of travel of the pedal, in both directions. In these designs, friction resists the release or deceleration direction used to return the accelerator to an idle position, as well as resisting depression/acceleration. Because these linkages between a friction element, and a pedal's extension were never releasable, these assemblies became problematic when the friction element became stuck against its friction generating surface, thereby rendering the entire pedal assembly also stuck and immovable. A failure to return to the idle position generates at least inefficiency consequences, and sometimes also safety issues.

### SUMMARY OF THE INVENTION

The present invention is a pedal assembly having an electronic position sensor for actuating acceleration and deceleration through electronic signals sent from the position sensor to a processor associated with a throttle to coordinate throttle acceleration, speed maintenance or deceleration to the position signals received from the pedal assembly. Appropriate resistance to pedal movement is generated by a friction element engaged with a friction surface. The pedal is fixedly attached to a pedal lever arm which is engaged with the friction element. In the present invention, the pedal lever arm is disengageable with the friction element, thereby allowing a return to idle in the event that the friction element becomes stuck. Moreover, at least one other inventive aspect of the present invention is a moveable engagement, as for example by pivoting, between a spring carrier and the friction element that allows biasing force from the spring to continue to be applied to the pedal lever arm, even when a portion of the spring carrier may be blocked by a stuck friction element. Thereby, the present invention allows a return to idle of the throttle and the throttle pedal in the event the friction element becomes stuck.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is an external side view of the pedal assembly.

FIG. 2 is a cutaway side view of the pedal assembly of FIG. 1.

FIG. 3 is another cutaway side view of the pedal assembly of FIG. 1.

### DETAILED DESCRIPTION OF THE PREFERRED EMBODIMENTS

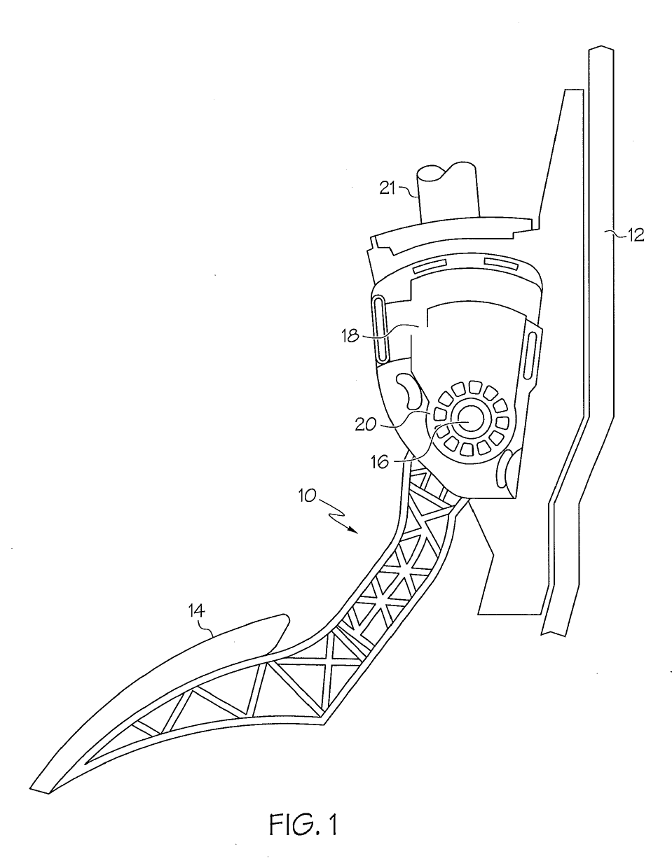

In the following description like reference numbers indicate like elements in the figures. FIG. 1 depicts an external side view of an accelerator pedal lever assembly 10 as attached to a schematically represented vehicle compartment wall 12. A pedal 14 is connected to rotate around a pivot 16 with the pivot, part of the pedal and other working parts contained within a housing 18. Located at the pivot 16 is a position sensor 20 which sends electronic signals through wires in a conduit 21, each of the electronic signals corresponding to a movement and a position of pedal 14.

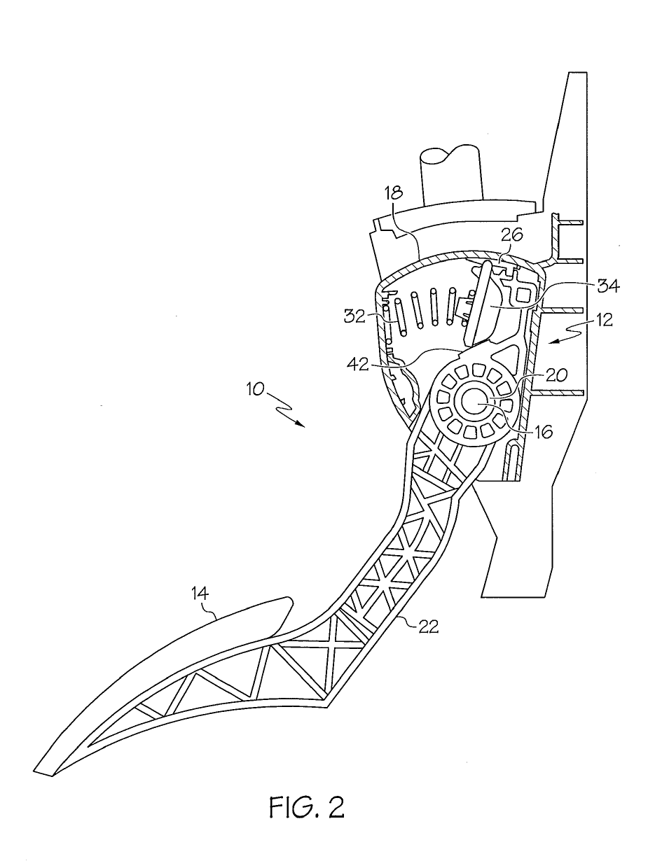

Further components of the present invention are depicted in the cutaway view of FIG. 2 in which pivot point 16 and its adjacent and related position sensor 20 may again be seen. FIG. 2 also shows pedal lever arm 22 extending into housing 18 and having a portion above pivot point 16. FIG. 2 shows pedal lever arm 22 in an idle position wherein pedal lever arm 22 engages friction element 26 which bears against housing 18. A spring 32 bears against a spring housing portion of a sidewall of housing 18 and extends across housing 18 wherein a spring carrier 34 engages both friction element 26 and a slip surface 42 of pedal lever arm 22.

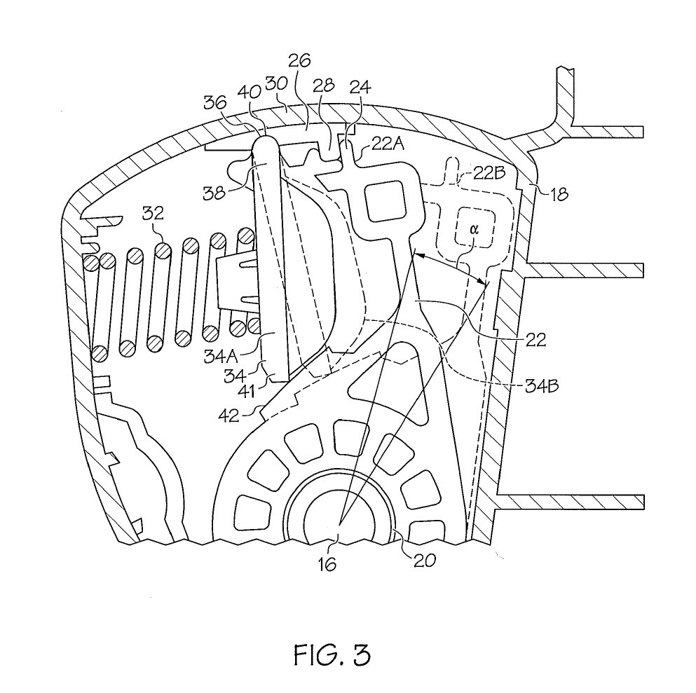

In the cutaway view of FIG. 3 may also be seen the pedal lever arm 22A and 22B. Pedal lever arm position 22B depicts the pedal lever arm in a park or idle position as indicated by the dashed or ghost lines. Pedal lever arm position 22A corresponds to depression of the pedal 14 for either acceleration or maintenance of a selected speed. Pedal arm 22 is displaced an angle of rotation a from pedal lever arm position 22B to pedal lever arm position 22A. Position sensor 20 may measure the angle or rotation a to electronically control the acceleration and speed of the vehicle.

FIG. 3 shows that pedal lever arm 22 includes a friction element engagement component 24. The engagement of the pedal lever arm 22 with a friction element 26 is releasable. In the depicted embodiment, the engagement component 24 is simply an open component having two extensions at right angles to one another dimensioned and disposed to interact with a friction element extension 28 such as to push against the friction element 26 in a first direction but, in the event the friction element is stuck, release from said friction element in a second direction. The second direction is towards an idle position as indicated by 22B in FIG. 2. In FIG. 2 may also be seen the friction element 26 in its engagement with a friction surface 30 to create friction. In the depicted embodiment, friction surface 30 is an inter surface of housing 18.

Also schematically depicted in FIG. 3 is spring 32. Spring 32 is disposed to bias the pedal lever arm 22 from any accelerated position to the idle position 22B. This biasing force is mediated by a spring carrier 34.

As may be best seen in FIG. 2 and FIG. 3, the friction element 26 is pushed across the friction surface 30 when depression of the pedal 14 raises pedal lever arm 22 away from the idle position 22B. This resists pedal movement due to the engagement of friction element extension 28 with pedal lever arm extension component 24. For the desired return movement, spring 32 biases a return of the pedal lever arm 22 from an acceleration or speed maintenance position 22A to idle position 22B via the spring carrier 34. In the event that the friction element 26 becomes stuck in any given position along the arc of friction surface 30, the desired return of pedal lever arm 22 to idle position 22B is still achieved as follows. The engagement of spring carrier 34 with friction element 26 is moveable. In the depicted embodiment, the movable engagement of spring carrier 34 with friction element 26 is via a pivoting engagement 36. At least a portion of top end 38 of the spring carrier 34 is received into and pivots within a receiving detent 36 of the friction element 26. Receiving detent 36 may be concave or arcuate in shape. Hence, spring carrier 34 is allowed to pivot about top end 38 within receiving detent 36 to continue to engage its contact with pedal lever arm 22 and to continue its biasing movement against it, even if the friction element 26 is stuck.

Spring carrier 34 moves from position 34A into position 34B via the pivoting motion created by the engagement of spring carrier extension 38 within friction element detent 36 as depicted at pivot 40 in FIG. 3. Biasing pressure against pedal lever arm 22 is actually had by the bottom end 41 of spring carrier 34 exerting its pressure against slip surface 42, which, in the depicted embodiment, is an integral part of pedal lever arm 22. In this manner, if when the driver releases pressure on the accelerator which in most cases indicates that a return of the accelerator to the idle position is desirable, if the friction element 26 becomes stuck in any non-idle position along friction surface 30, the pedal position is still pushed to the idle position by spring 32.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An accelerator pedal assembly having a pedal being fixedly attached to a pedal lever arm, said pedal and said pedal lever arm being disposed to move relative to a housing, a position sensor disposed to sense the position of said pedal lever arm relative to said housing, a friction element connected to the pedal lever arm to generate a resistive friction force on a friction surface that resists travel of said pedal lever arm in an acceleration direction, said friction element being movably engaged with a spring carrier such that a spring engaged with said spring carrier may bias said spring carrier, said friction element, and said pedal lever arm towards an idle position, the improvement comprising;
said pedal lever arm in releasable engagement with said friction element such that said resistive friction force resists pedal travel in an acceleration direction but does not resist said pedal lever arm returning to said idle position.

2. The accelerator pedal assembly of claim 1 wherein said pedal lever arm includes an engagement component to releasably engage an extension of said friction element.

3. The accelerator pedal assembly of claim 2 wherein said engagement component comprises two extensions at a substantially right angle to each other.

4. The accelerator pedal assembly of claim 1, the improvement further comprising said spring carrier being in pivotal engagement with said friction element allowing said spring and said spring carrier to exert a biasing force upon said pedal lever arm in the event said friction element becomes stuck.

5. The accelerator pedal assembly of claim 4, wherein said pivotal engagement further comprises at least a portion of a top end of said spring carrier being received into a detent in said friction element.

6. The accelerator pedal assembly of claim 4, wherein said biasing force is exerted by a bottom end of said spring carrier engaging a slip surface of said pedal lever arm.

7. An accelerator pedal assembly comprising:
a pedal;
a pedal lever arm, said pedal lever arm being fixedly attached to said pedal;
said pedal and said pedal lever arm being disposed to move relative to a housing;
a position sensor disposed to sense the position of said pedal relative to said housing;
a friction element;
a friction surface disposed to generate a friction force to resist travel of said friction element over said friction surface;
said pedal lever arm being releasably engaged with said friction element such that said friction force resists pedal travel in an acceleration direction but does not resist said pedal and said pedal lever arm from being returned to an idle position;
said friction element being movably engaged with a spring carrier such that a spring engaged with said spring carrier may bias said spring carrier, said friction element, and said pedal lever arm towards said idle position, and;
wherein if said friction element becomes stuck, said spring carrier is operable to move relative to said friction element allowing said spring and said spring carrier to apply a biasing force against a slip surface of said pedal lever arm to bias said pedal lever arm towards said idle position.

8. The accelerator pedal assembly of claim 7 wherein said pedal lever arm includes an engagement component to releasably engage an extension of said friction element.

9. The accelerator pedal assembly of claim 8 wherein said engagement component comprises two extensions at a substantially right angle to each other.

10. The accelerator pedal assembly of claim 7 wherein said spring carrier is in pivotal engagement with said friction element allowing said spring and said spring carrier to exert said biasing force upon said pedal lever arm.

11. The accelerator pedal assembly of claim 10, wherein said pivotal engagement further comprises at least a portion of a top end of said spring carrier being received into a detent in the friction element.

12. The accelerator pedal assembly of claim 10, wherein said biasing force is exerted by a bottom end of said spring carrier engaging said slip surface of said pedal lever arm.

13. The pedal assembly of claim 7 wherein said moveable disposition of said pedal and said pedal lever arm relative to said housing is a rotational disposition.

14. The accelerator pedal assembly of claim 7 further comprising said position sensor having an output, said output being configurable to signal a position of one of said pedal and said pedal lever arm to a throttle apparatus.

15. An accelerator pedal assembly comprising:
a pedal being fixedly attached to a pedal lever arm;
said pedal and said pedal lever arm being disposed for rotational movement relative to a housing;
a position sensor disposed to sense the position of said pedal lever arm relative to said housing;
a friction element engaged with a friction surface to generate a friction force to resist travel of said friction element over said friction surface;
said pedal lever arm being releasably engaged with said friction element such that said friction force resists pedal travel in an acceleration direction but does not resist said pedal lever arm from returning to an idle position;
said friction element having a detent that receives a top end of a spring carrier such that a spring engaged with said spring carrier may bias said spring carrier, said friction element, and said pedal lever arm towards said idle position in normal operation, and;
wherein said top end of said spring carrier may rotate within said detent such that said spring carrier may rotate about said top end thereby allowing a bottom end of said spring carrier to engage a slip surface of said pedal arm to bias said pedal lever arm towards said idle position if said friction element becomes stuck.
